(19) United States
(12) Patent Application Publication
(10) Pub. No.: US 2002/0014944 A1
(43) Pub. Date: Feb. 7, 2002

(54) Mechanical fuse for electric power line

(76) Inventor: Sean Dinsmore, Oakville (CA)

Correspondence Address: INGRID E. SCHMIDT, GOWLING LAFLEUR HENDERSON LLP, SUITE 560-120 KING STREET WEST, PO BOX 1045, LCD 1, HAMILTON, ON, L8N 3R4, CA

(21) Appl. No.: 09/827,920

(22) Filed: Apr. 9, 2001

Related U.S. Application Data
(60) Provisional application No. 60/195,319, filed on Apr. 10, 2000.

(51) Int. Cl. H01H 71/20; H01H 73/24

(52) U.S. Cl. 337/157

(57) ABSTRACT

A mechanical fuse and fuse assembly for a power line assembly is designed to fail under a predetermined physical load so as to protect a power line supporting structures and associated equipment. The fuse is a length of frangible metal with a reduced diameter portion, coupled to a housing so as to be placed in tension when placed under a load. The housing has terminations for coupling to power line hardware. The fuse is threaded at one end and has a bolt head at the other end while the housing is provided in two separable portions, one of which is threaded to receive the threaded end of the fuse while the other portion has a through bore to receive the fuse and locate the bolt head. The housing portions are keyed to prevent relative rotation.

This application claims priority from U.S. Provisional Application No. 60/195,319 filed on Apr. 10^{th}, 2000.

### FIELD OF THE INVENTION

This invention relates to a mechanical fuse which is designed to fail under a predetermined physical load so as to protect power line assemblies including poles, towers, insulators and associated hardware.

### BACKGROUND OF THE INVENTION

In climates where winter is severe, it is not uncommon for exposed power line cables and wood poles or steel support towers to become coated with ice and to physically break under the load from the added weight and strain carried by the equipment, with the result that electrical service is interrupted, and in severe cases, supporting structures and equipment attached thereto must also be replaced or repaired.

An object of this invention is to provide a safety device, or fuse, which will fail under a predetermined physical load so as to protect power line assemblies and to obviate the problems associated with cables which rupture under heavy loads.

### SUMMARY OF THE INVENTION

In accordance with this invention, there is provided a mechanical fuse and fuse assembly for a power line assembly, the fuse comprising a length of frangible material, preferably metal with a reduced diameter portion, coupled to a housing so as to be placed in tension when placed under a load. The housing has terminations for coupling to a power line hardware.

Most preferably, the fuse is threaded at one end and has a bolt head at the other end while the housing is provided in two separable portions, one of which is threaded to receive the threaded end of the fuse while the other portion has a through bore to receive the fuse and locate the bolt head. The housing portions are keyed to prevent relative rotation.

### BRIEF DESCRIPTION OF THE DRAWINGS

In order that the invention may be more clearly understood, a preferred embodiment is described below with reference to the accompanying drawings, in which:

FIG. 1 is a top elevation view showing a fuse assembly in accordance with the invention;

FIG. 2 is a side elevation view of the fuse assembly of FIG. 1;

FIG. 3 is a side elevation view of a fuse element in accordance with the invention;

FIG. 4 is a side elevation view of a first portion of the housing comprising the fuse assembly;

FIG. 5 is a cross-sectional view drawn on line 5-5 of FIG. 4,

FIG. 6 is an end elevation view of the first portion of the housing shown in FIG. 4;

FIG. 7 is a side elevation view of a second portion of the housing comprising the fuse assembly;

FIG. 8 is a side elevation view of the second portion of the housing shown in FIG. 4; and

FIG. 9 is an end elevation view of the second portion of the housing shown in FIG. 7.

### DESCRIPTION OF PREFERRED EMBODIMENT WITH REFERENCE TO THE DRAWINGS

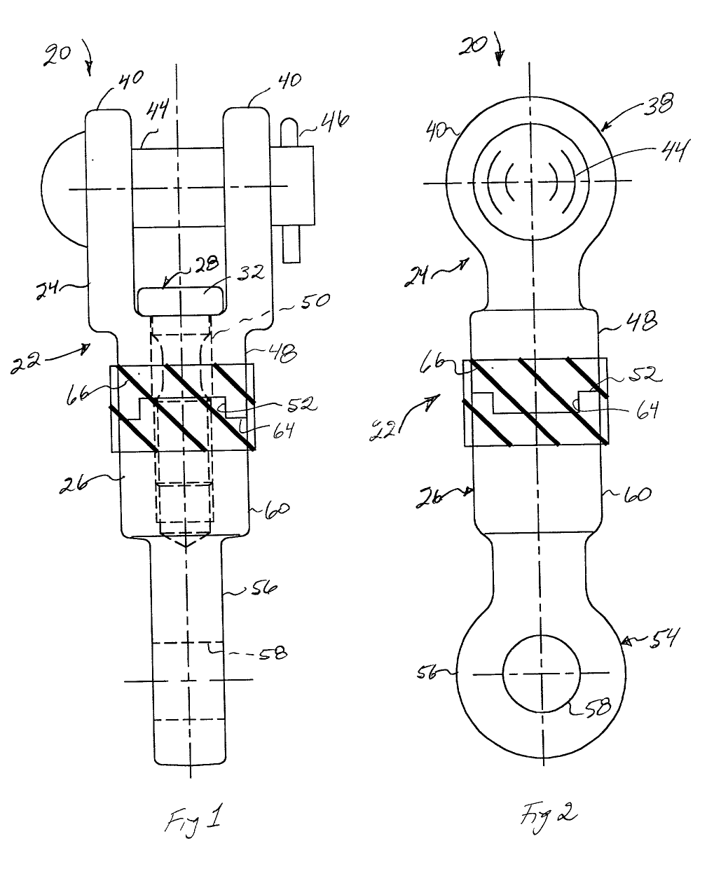

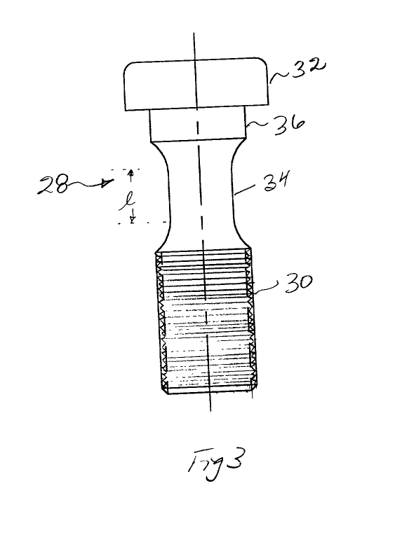

A fuse assembly in accordance with the invention is generally indicated by reference numeral 20 in FIGS. 1 and 2 of the accompanying drawings. The fuse assembly 20 comprises a housing 22 having a first portion 24 separable from a second portion 26 and a fuse 28 received inside the housing 22. The fuse 28 is shown in more detail in FIG. 3 and comprises a machined length of copper rod having a threaded end 30 and a bolt head 32 spaced from each other by a reduced diameter portion 34 which is designed to fail at a predetermined design load. It will be seen that there is a smooth transition from the threaded end 30 to the reduced diameter portion 34 and to a shaft portion 36 adjacent the head 32 so that there is no stress concentration in the reduced diameter portion 34. Further, the reduced diameter portion 34 has a constant diameter over a portion of its length indicated as “l” in FIGS. 3 which is at least as long as the corresponding diameter.

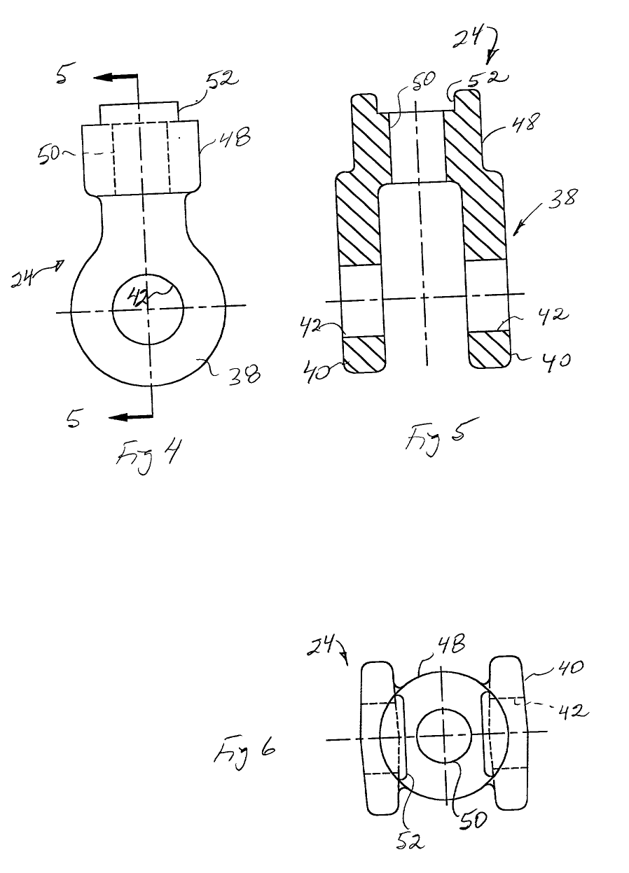

The construction of the housing 22 for receiving the fuse 28 will now be described with reference being made to FIGS. 4 to 6 and 7 to 9.

The first portion 24 of the housing is shown in FIGS. 4 to 6 and has a bifurcated or clevis termination 38 which has spaced parallel arms 40 each having a respective aperture 42 for receiving a connecting pin 44 (see FIG. 1) held in place with a cotter pin 46. The arms 40 are joined at one end by a collar 48 which has an axial through bore 50 for receiving the fuse 28 therethrough and a sufficiently small diameter to locate the head 32 of the fuse 28 against the collar 48. A shouldered recess 52 is machined into the free end of the collar 48 for cooperation with the second portion 26 of the housing 22, as will be described further below.

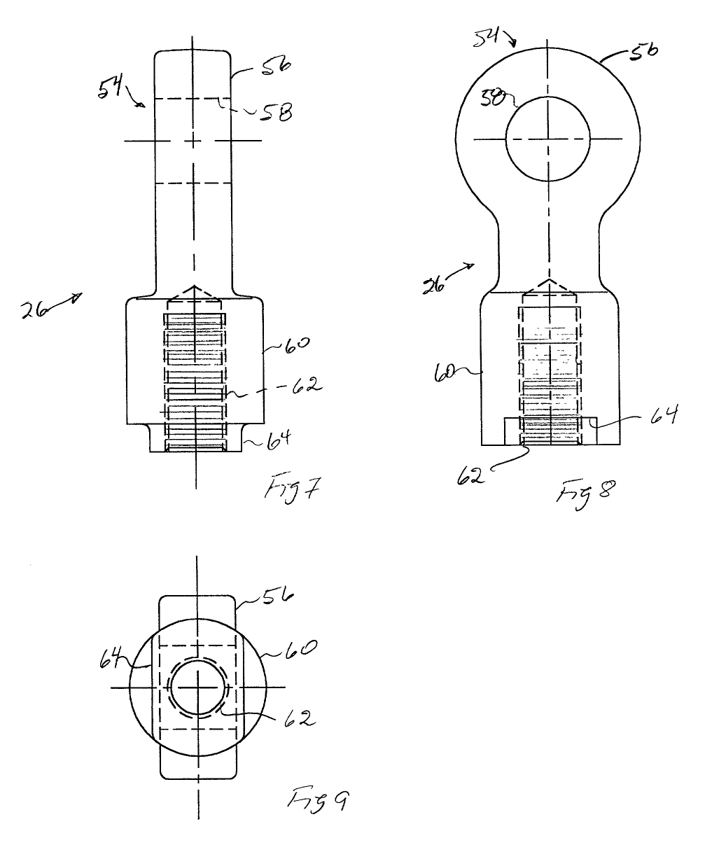

The second portion 26 of the housing 22 is described with particular reference being made to FIGS. 7 to 9. The second portion 26 has a ring termination 54 comprising a single arm 56 with a central aperture 58 extending from a collar 60. A threaded, blind hole 62 is machined axially into the collar 60 and is adapted to operate with the threaded end 30 of the fuse 28. The outer free end of the collar 60 remote from the ring termination 54 has a reduced diameter portion or notch 64 dimensioned to be received within the shouldered recess 52 of the first portion 24 of the housing 22.

In use, the fuse element 28 is placed in the first portion 24 of the housing 22 such that the bolt head 32 is located between the arms 40 of the clevis termination 38 against the collar 48 such that the shaft 36 together with a portion of the reduced diameter portion 34 are received through the bore 50. The threaded end 30 of the fuse is then threaded to the threaded blind hole 62 of the second portion 26 of the housing 22 and the notch 64 is aligned with the shouldered recess 52 so that the first and second portions 24, 26 of the housing 22 are keyed and cannot rotate relative to each other thereby preventing any torsion being applied to the fuse element 28. If desired, the cavity defined by the blind hole 62 and bore 50 may be filled with a conductive fluid such as grease in order to define a conductive path between the fuse element 28 and the housing 22, as necessary. Such an enhanced conductive path will be desirable for circumstances where the fuse assembly 20 should not be required to fail for electrical reasons such as during a lighting strike, a short circuit or any electrical surges in the power line assembly.

The junction between the first and second portions 24, 26 is sealed with a seal 66 (FIGS. 1, 2) comprising a cylinder of heat shrinkable, synthetic plastic material which is slipped over the assembly and heated to shrink the material so that it bonds to the housing 22. Conveniently, the inside surface of the seal 66 has adhesive to enhance bonding and the material may be colour coded to give a visual indication of the physical load which the fuse 28 is designed to withstand. The condition of the seal 66 will also give a visual indication of whether there has been any tampering of the fuse assembly 20.

It is intended that the fuse assembly 20 will be retrofitted to existing power line assemblies and would commonly be coupled to a power line insulator (not shown) at one end and a clamp (not shown) at the other end for holding a power line cable whether in a dead-end application or for a suspended power cable assembly. As will be appreciated by those skilled in the art, the clevis termination 38 and ring termination 54 are of a standard design intended to be coupled to standard terminations found in pole line hardware. Their configuration, accordingly, may be changed in accordance with the intended applications.

It will be understood that the fuse 28 is placed tension during application of a physical load to a power cable and that the diameter of the reduced diameter portion 34 is determinative of the load which can be sustained before the fuse will snap, for example, between 3000 lbs. and 5500 lbs., depending on the selected diameter. When the fuse element 28 snaps, the associated cable will drop but the associated pole or support will remain erect and any hardware coupled to the support will also be protected from damage which could result from the support collapsing or failing in an unpredictable fashion.

As will appreciated, several variations may be made to the above described invention within the scope of the appended claims. In particular, it will be appreciated that the use of a housing is a convenience and that the fuse may, with appropriate terminations, be used without a housing. The nature of the housing itself could also vary considerably.

1. A mechanical fuse for a power line comprising a length of frangible material having two ends, each end being adapted to be coupled to a respective termination for coupling to a power line assembly, the material being adapted to break under a predetermined tension applied to said ends.

2. Mechanical fuse according to claim 1 comprising a length of metal threaded at one end and having a bolt head at the other end.

3. Mechanical fuse according to claim 1 having a reduced diameter portion between the ends which is adapted to break under said predetermined tension.

4. Mechanical fuse assembly according to claim 3 in which the reduced diameter portion has a length equal to at least the diameter in said portion.

5. Mechanical fuse according to claim 1 fabricated from nickel plated copper.

6. A mechanical fuse assembly for a power line assembly comprising a housing having a first portion separable from a second portion, each portion having a respective termination for coupling to a power line assembly and a fuse coupled to the housing, the fuse comprising a length of frangible material having two ends, each end being coupled to one of said housing portions, the material being adapted to break under a predetermined tension applied to said ends.

7. A mechanical fuse assembly according to claim 6 in which the fuse is a length of metal having a threaded end and a bolt head at the other end, the first portion of said housing being threaded to receive the threaded end of the fuse and the second portion of said housing being apertured to locate the bolt head.

8. A mechanical fuse assembly according to claim 6 in which the fuse has a reduced diameter portion between the ends which is adapted to break under said predetermined tension.

9. A mechanical fuse assembly according to claim 8 in which the reduced diameter portion has a length equal to at least the diameter in said portion.

10. A mechanical fuse assembly according to claim 6 in which the first and second housing portions have respective, keyed end portions cooperable with each other for preventing relative rotation of said first and second portions, said end portions being apertured to receive the fuse therein and shield the fuse from the elements.

11. A mechanical fuse assembly for a power line assembly comprising a housing having a first portion separable from a second portion, each portion having a respective termination for coupling to a power line assembly, and a fuse received within the housing, the fuse comprising a length of frangible material having a threaded end and a bolt head at another end, the first portion of said housing having a threaded aperture to receive the threaded end of the fuse, and the second portion of said housing having a bore to receive the fuse therethrough and locate the bolt head, said first and second portions of the housing having respective keyed end portions cooperable with each other for preventing relative rotation of said first and second portions, the frangible material being adapted to break under a predetermined tension applied to said end of the fuse.

12. A mechanical fuse assembly according to claim 11 having a cylindrical seal coupling said first and second portions of the housing and shielding said fuse.

13. A mechanical fuse assembly according to claim 11 having an electrically conductive fluid disposed in a cavity defined by said bore and said threaded aperture to enhance conductivity between said fuse and said housing.

14. A mechanical fuse assembly according to claim 11 in which the housing portions have respective terminations selected from the following group: a ring termination and a clevis termination.

15. A mechanical fuse assembly according to claim 11 in which the fuse has a reduced diameter portion between the ends which is adapted to break under said predetermined tension.

16. A mechanical fuse assembly according to claim 11 in which the reduced diameter portion has a length equal to at least the diameter in said portion.

17. Mechanical fuse assembly according to claim 11 in which the fuse is fabricated from nickel plated copper.

18. Mechanical fuse assembly according to claim 11 in which the housing is fabricated from galvanized steel.
